(19) United States
(12) Patent Application Publication
(10) Pub. No.: US 2026/0311467 A1
(43) Pub. Date: Oct. 8, 2026

(54) SEQUENCE PACKING FOR TRAINING IMAGE PROCESSING NEURAL NETWORKS

(71) Applicant: Google LLC, Mountain View, CA (US)

(72) Inventors: Mostafa Dehghani, Amsterdam (NL); Basil Mustafa, Zurich (CH); Jonathan Heek, Hilversum (NL); Josip Djolonga, Zurich (CH)

(21) Appl. No.: 19/485,182

(22) PCT Filed: May 17, 2024
(86) PCT No.: PCT/US2024/030005

§ 371 Date: Nov. 17, 2025

Related U.S. Application Data
(60) Provisional application No. 63/467,296, filed on May 17, 2023.

(51) Int. Cl. G06V 10/774; G06V 10/764; G06V 10/82

(52) U.S. Cl. CPC G06V 10/774; G06V 10/764; G06V 10/82

(57) ABSTRACT

Methods, systems, and apparatus, including computer programs encoded on computer storage media, for training an image processing neural network. For example, a method can include obtaining a batch of training examples, each training example comprising a respective training image; generating one or more input sequences, wherein each input sequence corresponds to two or more of the training images in the batch and is a sequence of tokens that comprises tokens representing patches from two or more corresponding training images; and processing each input sequence using the image processing neural network to generate a respective training output for each corresponding training image; and training the image processing neural network on a first loss function for the first task using the training outputs for the training images in the batch.

### CROSS-REFERENCE TO RELATED APPLICATIONS

This application claims the benefit of priority to U.S. Provisional Patent Application No. 63/467,296, filed on May 17, 2023, the contents of which are hereby incorporated by reference.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains an image processing neural network.

The image processing neural network is a neural network that receives an input image and processes the input image to generate an output for the image.

Particular embodiments of the subject matter described in this specification can be implemented so as to realize one or more of the following advantages.

Vision Transformers (ViT) and other neural networks, e.g., Vision Transformer variants, MLP-Mixer neural networks, and so on, that process sequences of patches from images have shown very strong performance on a variety of computer vision tasks. However, these neural networks generally require that, during training, input images are resized to a fixed resolution and a fixed aspect ratio, e.g., a square aspect ratio, and then split into a fixed number of patches before they are processed by the neural network.

This specification, by contrast, describes an alternative approach where, during training, multiple patches from multiple different images are “packed” into a single input sequence. That is, a single input sequence during training can include patches from multiple different input images and these different input images can have different resolutions, different aspect ratios, or both.

Training the neural network in this manner can enable variable resolution images to be processed at inference, can improve training efficiency and downstream inference performance, and allow for incorporating a variety of other techniques that may further improve the efficacy of the training. Examples of such techniques include randomly sampled token dropping and resolution sampling.

That is, by modifying the training scheme of an image processing neural network as described in this specification, the image processing neural network can be trained to have improved performance at inference time while being able to accurately process images of different resolutions and aspect ratios. Moreover, the neural network can achieve this improved performance while consuming fewer computational resources during training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for performing a training step during the training of the image processing neural network.

FIG. 3 is a flow diagram of an example process for generating an input sequence when token dropping is employed.

FIG. 4 is a flow diagram of an example process for obtaining a batch when resolution sampling is employed.

FIG. 5 shows an example of generating an input sequence and processing the input sequence using the image processing neural network.

FIG. 6 shows an example of the performance of the described techniques.

Like reference numbers and designations in the various drawings indicate like elements.

### DETAILED DESCRIPTION

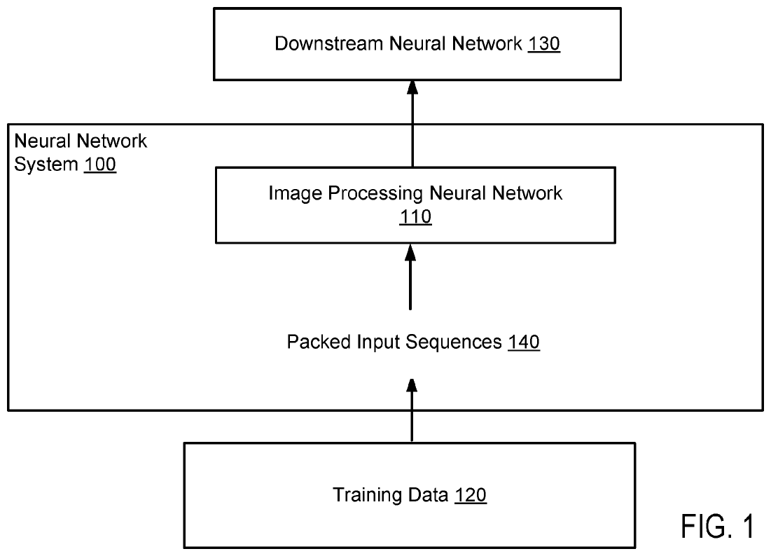

FIG. 1 shows an example neural network system 100. The neural network system 100 is an example of a system implemented as computer programs on one or more computers in one or more locations, in which the systems, components, and techniques described below can be implemented.

In particular, the system 100 is a system that trains an image processing neural network 110 on training data 120.

The image processing neural network 110 is a neural network that receives an input image and processes the input image to generate an output for the image.

For example, the output for the image can be an image embedding of the input image in an embedding space. An “embedding” as used in this specification is a vector of numeric values, e.g., floating point values or other values, having a pre-determined dimensionality. The space of possible vectors having the pre-determined dimensionality is referred to as the “embedding space.” In other words, an embedding of an image is an encoding of the image.

As another example, the output for the image can be a classification output for a classification task for the input image. That is, the output includes a respective score for each of a set of object categories, with the score for an object category representing the likelihood that the image depicts an object belonging to the object category.

After being trained, the image processing neural network 110 can be adapted for one or more downstream tasks. In other words, the training performed by the system 100 on the training data 120 can be referred to as a “pre-training” stage that is performed in order to improve how well and how easily the neural network 110 can be adapted for one or more downstream tasks after being trained on the training data 120.

To adapt the image processing neural network 110, the system 100 can train a downstream neural network 130 that includes at least some of the layers of the image processing neural network 110 on training data for the downstream task.

For example, the downstream task can be an image classification task, as described above.

As another example, the downstream task can be object detection, e.g., open vocabulary object detection, where the output for a given image identifies locations of one or more bounding boxes in the image and, for each bounding box, a category to which an object depicted in each bounding box belongs. One example of an object detection task is an open vocabulary object detection task, where the set of possible categories can be different for different inputs and are specified by embeddings of category labels generated by a text encoder neural network. For example, in open vocabulary object detection, for each bounding box, the system can select the category label embedding having the highest similarity, e.g., in terms of cosine similarity or dot product, with an embedding of the bounding box generated by the downstream neural network.

As another example, the downstream task can be image segmentation. That is, the neural network can be configured to generate an element-level classification output (e.g., a pixel-level classification output) that includes, for each element in the network input, a respective score corresponding to each of multiple categories. For a given element (e.g., for a given pixel), the score for a category indicates a likelihood that element belongs to the category. In some cases, the categories may be classes of objects, and an element may belong to a category if it is part of an object included in the object class corresponding to the category.

As another example, the downstream task can be image depth prediction. In a depth prediction task, the output generated by the neural network identifies, for each pixel in the image, a predicted depth of the scene at the pixel.

As another example, the downstream task can be a video understanding task. That is, the neural network can be configured to process a sequence of video frames to generate an output that characterizes the video frames, e.g., by characterizing whether the video frames depict a person or other agent performing a particular action, by generating a caption that describes the semantic content of the video, by classifying one or more objects in the video and so on.

As another example, the downstream task can be a multi-modal text and vision task, e.g., image captioning, where the input is an image and the output is a text caption describing the input image, or visual question answering, where the input is an image or a video and a question about the image or video and the output is an answer to the question.

The image processing neural network 110 can have any appropriate architecture that processes a sequence of tokens representing an image to generate the output for the image.

For example, the neural network 110 can have an architecture that includes multiple self-attention network blocks that each perform self-attention to update the tokens in the sequence. Examples of such architectures include Vision Transformers (ViTs) and other ViT variants. As a particular example, the neural network can have the architecture described in Dosovitskiy, et al, An Image is Worth 16×16 Words: Transformers for Image Recognition at Scale, arXiv:2010.11929.

As another example, the neural network 110 can have an architecture that includes multiple network blocks that perform a different type of operation to update the tokens in the sequence. An example of such an architecture is an MLP-mixer architecture. As a particular example, the neural network can have the architecture described in Tolstikhin, et al, MLP-Mixer: An all-MLP Architecture for Vision, arXiv:2105.01601.

In any of the above examples, the neural network 110 can include a sequence of network blocks that each update the tokens in the input sequence. The neural network 110 can also include one or more additional neural network layers that process the outputs of the last network block in the sequence to generate the training output.

When adapting the neural network 110 for a new downstream task, the system 100 or another adaptation system can replace the one or more additional neural network layers with a set of additional neural networks layers that are specific to the downstream task. The system 100 can then train the resulting downstream neural network on training data for the downstream task, either holding the network blocks fixed and training only the new additional layers or training both the new additional layers and the network blocks.

More specifically, given an input image, the neural network 110 divides the input image into patches. The neural network 110 then generates a respective embedding for each patch and processes a sequence that includes the embeddings for the patches to generate the training output for the input image.

Dividing an image into patches and generating embeddings of patches will be described in more detail below.

Generally, the training data 120 includes multiple different training examples, with each training example including at least a training image and, optionally, other data, e.g., a classification label or a corresponding text sequence.

The training images in the training examples generally have varying resolutions and aspect ratios. However, conventional training schemes for training these neural networks generally require that the training images are resized to a fixed resolution and a fixed aspect ratio, e.g., a square aspect ratio, and then split into a fixed number of patches before they are processed by the neural network 110.

In order to improve upon these conventional training schemes and as described in more detail below, the system 100 trains the neural network 110 by “packing” multiple images into any given “packed” input sequence 140 that is processed by the neural network 110 during training.

Training the neural network 110 in this manner has many implications for the training of the neural network 110 and for subsequently fine-tuning and using (at least a portion) of the neural network 110 to perform inference.

For example, at a fixed computational budget, the described training scheme consistently outperforms conventional approaches. For instance, the described training scheme can result in a neural network 110 that matches the performance of a Vision Transformer (ViT) trained using previously state-of-the-art techniques with 4× less compute. As one example, because sequence packing results in multiple images being combined within the same input sequence, there is a substantial increase in the number of training examples processed within the allocated compute budget, which contributes to the increase in performance. As another particular example, sequence packing coupled with variable resolution inputs and variable token dropping (described below) enable the system 100 to process five times more images during training than conventional schemes. Additionally, this improved efficiency extends to the fine-tuning process, where similar schemes can be applied.

Furthermore, by exposing the neural network 110 to multiple resolutions during both pre-training and fine-tuning, a single model demonstrates excellent performance when evaluated on various resolutions, significantly advantaging the neural network 110 in terms of inference cost relative to neural networks trained using conventional schemes.

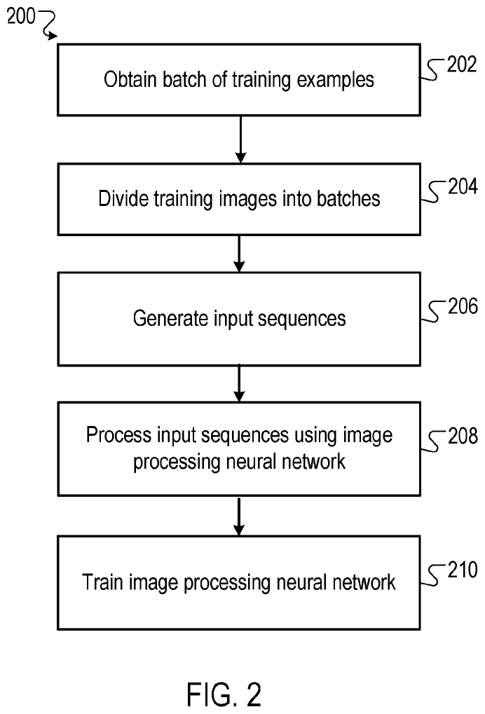

FIG. 2 is a flow diagram of an example process 200 for performing a training step during the training the image processing neural network. For convenience, the process 200 will be described as being performed by a system of one or more computers located in one or more locations. For example, a neural network system, e.g., the neural network system 100 of FIG. 1, appropriately programmed, can perform the process 200.

Generally, the system can perform the training of the image processing neural network across multiple training steps. At each training step, the system obtains a batch of training examples and trains the image processing neural network on the training examples in the batch, i.e., by performing an iteration of the process 200.

To perform the training, the system obtains a batch of training examples, with each training example including a respective training image (step 202).

In some cases, the training example includes only the image. In other cases, however, the training example includes other information, e.g., a corresponding text sequence that describes the image or data identifying a label for the image.

Generally, the batch of training examples can include images with varying resolutions and aspect ratios.

In some implementations, the system trains the neural network on the original resolutions of the training images in the batch.

In some other implementations, the system makes use of resolution sampling when generating the batch of training images.

More specifically, in conventional training schemes, there is a tension between greater throughput during training (training on smaller images), and greater performance (training on larger images, to enable use of high-resolution images at evaluation time). As a result, oftentimes, models are pre-trained at a smaller resolution and finetuned at a higher one. However, by making use of resolution sampling, the described techniques are much more flexible because they can allow mixed-resolution training by sampling from a distribution of image sizes, while retaining each image's original aspect ratio. This allows both higher throughput and exposure to large images, yielding substantial improved performance, e.g., over equivalent ViTs (in terms of models size and training duration).

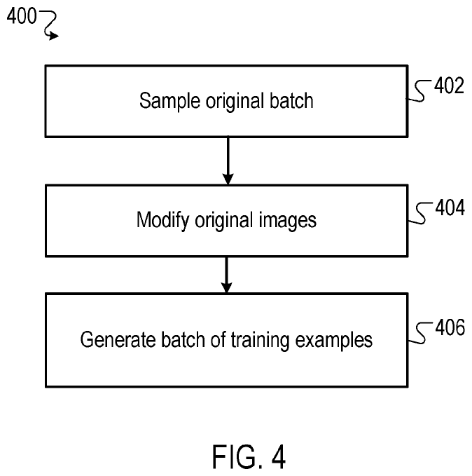

Resolution sampling is described in more detail below with reference to FIG. 4.

For each training image in the training examples, the system divides the training image into a respective plurality of patches and generates a respective token representing each of the patches (step 204).

To divide a training image into patches, the system can partition each image into fixed size regions. Even though the regions have a fixed size, because different images have different resolutions, different images can be divided into different numbers of patches.

Generally, to generate the tokens representing the patches, the system generates a patch embedding of the patch and generates a positional embedding of a position of the patch within the corresponding training image.

The system then combines the patch embedding of the patch and the positional embedding of the patch to generate the respective token representing the patch. For example, the system can sum, average, or concatenate the patch embedding and the positional embedding.

To generate the patch embedding of any given patch, the system can process the intensity values of the pixels in the patch using a patch embedding subnetwork to generate the patch embedding of the patch. For example, the patch embedding subnetwork can be a single linear projection layer, can be a multi-layer subnetwork, e.g., an MLP, or have a different appropriate architecture.

Generally, the patch embedding subnetwork is trained jointly with the remainder of the image processing neural network, e.g., is trained using gradients of the loss function, computed as described below.

The system can generate the positional embedding of the position of a given patch within the corresponding training image in any of a variety of ways.

For example, the system can use one dimensional (1-D) positional embeddings that map each coordinate to a position in a 1-D, flattened representation of the image and are learned jointly with the remainder of the neural network.

As another example, the system can use two-dimensional (2-D) positional embeddings that are learned jointly with the remainder of the neural network.

That is, in this example, a respective embedding for each index in a [maxLen, maxLen] grid is learned, with the grid being indexed with the (x, y) coordinates of each patch and maxLen being a pre-set maximum length of any given dimension of an image. This enables variable aspect ratios, with resolutions of up to R=P·maxLen, where P is the number of patches from any given image. However, every combination of (x, y) coordinates must be seen during training. For example, the coordinate of a given patch for a given dimension can represent the index of the patch along the given dimension in terms of numbers of patches, e.g., so that x=2 will be the second patch along the x dimension.

However, while 2D embeddings support variable aspect ratios, neither of the above encoding schemes readily extrapolate to unseen resolutions. To address this issue, in some implementations, the system uses “factorized” positional embeddings.

In this scheme, the system maintains a separate set of embeddings for each of a set of multiple x coordinates and a separate set of embedding for each of a set of multiple y coordinates.

In some cases, the embeddings are absolute embeddings, so that the embedding of a given coordinate is a function of the absolute index of the coordinate within the image.

In some other cases, the embeddings are fractional embeddings, so that the embedding of a given coordinate is a function of the ratio of the absolute index of the coordinate within the image to the side length of the image along the corresponding dimension, i.e., the number of patches along the corresponding dimension for the given image.

When using factorized positional embeddings, to determine the positional embedding for a given patch, the system generates a first embedding of an x coordinate of the position of the patch within the corresponding training image, e.g., by mapping the absolute index of the coordinate to the first embedding, or by mapping the ratio of the coordinate within the image to the side length of the image along the x dimension to the first embedding.

The system generates a second embedding of a y coordinate of the position of the patch within the corresponding training image, e.g., by mapping the absolute index of the coordinate to the second embedding, or by mapping the ratio of the coordinate within the image to the side length of the image along the y dimension to the second embedding.

The system then combines the first and second embeddings to generate the positional embedding of the position of the patch.

For example, the system can sum the first and second embeddings to generate the positional embedding of the position of the patch.

As another example, the system can stack, i.e., concatenate, the first and second embeddings to generate the positional embedding of the position of the patch.

As another example, the system can element-wise multiply the first and second embeddings to generate the positional embedding of the position of the patch.

When using the factorized scheme, the set of embeddings for the x dimension and the set of embeddings for the y dimension can be learned jointly with the remainder of the neural network, e.g., as standard learned embeddings or learned Fourier positional embeddings, or can be determined prior to training, e.g., as sinusoidal embeddings.

The system generates one or more input sequences (step 206). Generally, the one or more input sequences collectively represent all of the images in the batch.

Each input sequence corresponds to two or more of the training images in the batch and is a sequence of tokens that includes tokens representing patches from the two or more corresponding training images.

That is, the system generates the input sequences using sequence packing by “packing” tokens from multiple images into the same input sequence.

Generally, because the images in the batch can have variable resolutions and aspect ratios, one sequence can include tokens from two different images with two different resolutions, two different aspect ratios, or both.

In particular, as described above, the number of tokens that represent an image can depend on the resolution of the image, so that images with different resolutions are represented by different numbers of tokens. Thus, any given input sequence can include different numbers of tokens for two different images with two different resolutions.

In some implementations, the system employs a toking dropping scheme when generating each input sequence. As part of employing token dropping, the system can determine, for each image, whether to remove any of the tokens that represent the image from the input sequence and then generate the input sequence with only the tokens that have not been removed from each of the two or more input images.

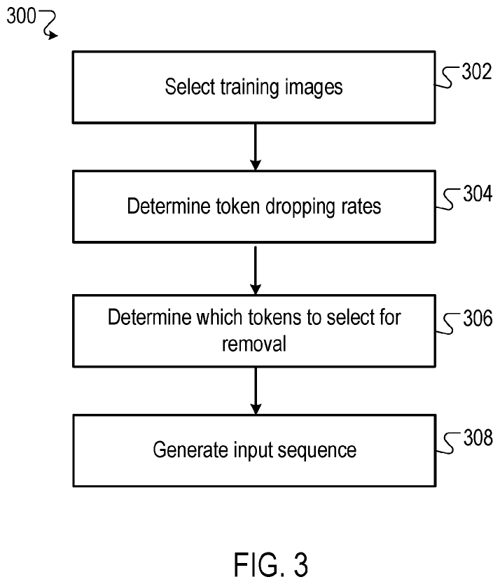

This will be described in more detail below with reference to FIG. 3.

The system can determine which images in a given batch are represented in which input sequence in any of a variety of ways.

For example, in some implementations, each input sequence must include the same, maximum number of tokens, i.e., in order to optimize the performance of the hardware on which the neural network is being trained, e.g., tensor processing units (TPUs) or other ASICs that are optimized for fixed size inputs.

In these implementations, the system can generate input sequences using a greedy approach in which the system adds images to the first sequence with enough remaining space. That is, the system can traverse the images in the batch, e.g., according to a random ordering of the images, and can determine whether the tokens representing the image can “fit” within any already generated, partially complete input sequence. If so, the system adds the image to one of the partially complete input sequence. If not, the system places the image in a new sequence. Once no more images can fit in any of the generated sequences, sequences are filled with padding (“masking”) tokens, yielding the fixed sequence lengths.

As another example, rather than using masking tokens, when generating a given input sequence, the system can dynamically choose the resolution or token dropping rate of the final image in the sequence to exactly fit the remaining tokens in the given input sequence.

The system then processes each input sequence using the image processing neural network to generate a respective training output for each corresponding training image (step 208).

For example, when the image processing neural network includes a sequence of self-attention layers, the system processes the input sequence through the sequence of self-attention layers to update the tokens in the input sequence and then generates the training output for each training image from the updated tokens.

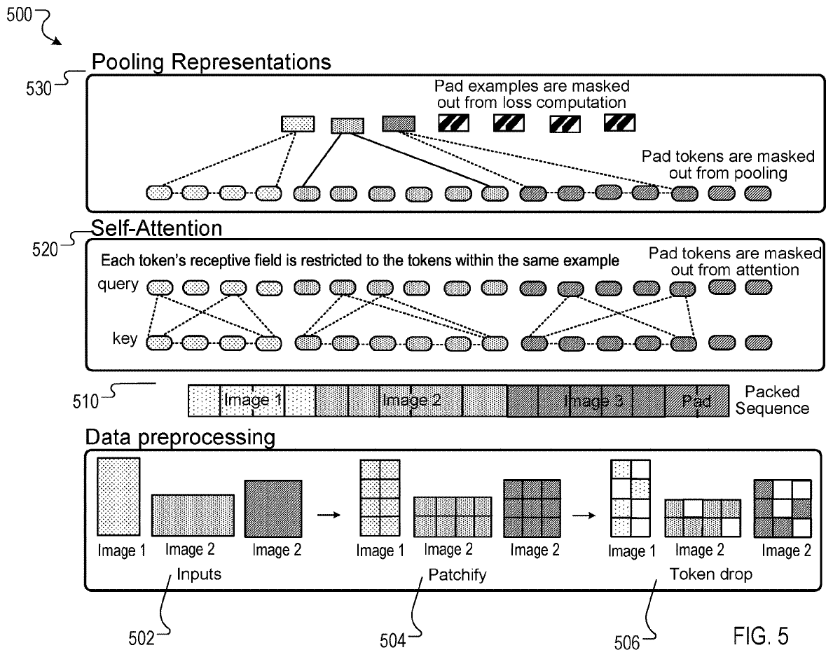

An example of this is described below with reference to FIG. 5.

The system trains the image processing neural network on a loss function for the task using the training outputs for the training images in the batch (step 210). For example, the loss function can be a contrastive loss function or a classification loss function, e.g., a loss function with a cross-entropy term.

More specifically, in some cases, the system trains the neural network through contrastive learning. In these cases, the training output generated by the image processing neural network for each image is an image embedding of the image in an embedding space.

Additionally, the image processing neural network is trained jointly with a text encoder neural network having text encoder neural network parameters and configured to process a text segment to generate a text embedding of the text segment in the embedding space. For example, the text encoder neural network can be a Transformer neural network, a recurrent neural network (RNN) or another appropriate type of text processing neural network.

Thus, in these cases, each training example also includes a respective training text segment, e.g., a text segment that has been determined to be semantically similar to the training image in the training example. For example, within a given training example, the text segment can be a text annotation of the image from a set of manually or automatically generated image annotations or can be alt text associated with the image in a set of alt-text data. Alt text is text that is displayed in place of an image on a web page, e.g., if the image cannot be rendered properly or otherwise fails to load. For example, the system can obtain the alt-text data from data maintained by an Internet search engine or other software that automatically crawls web pages on the Internet.

To train the image processing and text encoder neural networks in these cases, the system can, for each training text segment, process the training text segment using the text encoder neural network to generate a training text embedding of the training text segment.

The system can then train the image processing and text encoder neural networks on a contrastive loss function that is based on similarities between the training text embeddings and the training image embeddings.

In some other cases, the system trains the image processing neural network on an image classification task. In these cases, the training output generated by the image processing neural network can be a classification output and each training example includes a ground truth classification for the training image in the training example. Thus, the system trains the image processing neural network on a loss function that includes, for each training example, a classification loss relative to the ground truth classification for the training image, e.g., a cross-entropy or other classification loss.

As described above, after repeatedly performing iterations of the process 200 to train the image processing neural network, the system can then adapt the image processing neural network to perform a downstream computer vision task. Examples of such tasks include image classification, object detection, image segmentation, depth prediction, video understanding, and multi-modal text and vision tasks.

FIG. 3 is a flow diagram of an example process 300 for generating an input sequence when the system performs token dropping. For convenience, the process 300 will be described as being performed by a system of one or more computers located in one or more locations. For example, a neural network system, e.g., the neural network system 100 of FIG. 1, appropriately programmed, can perform the process 300.

Token dropping (i.e., the random omission of input patches during training) has been developed to accelerate training. However, typically the same proportion of tokens are dropped from all examples. By making use of sequence packing, the system enables continuous token dropping, whereby the token dropping rate can be varied per-image. This enables the benefits of faster throughput enabled by token dropping while still allowing the model to process some complete images, reducing the train/inference discrepancy and improving performance at inference time. Further, with packing, the drop-distribution can vary throughout training, further improving training performance.

The system selects two or more of the training images in the batch of training examples (step 302). For example, the system can select the training images that will be represented in the training sequence greedily as described above.

The system determines, for each of the two or more training images, a respective token dropping rate (step 304).

In some cases, the respective token dropping rate is the same for all of the training images in the batch. In these cases, the system can determine the token dropping rate for the batch of training images in any of a variety of ways.

As one example, the system can randomly sample the respective token dropping rate for the batch from a set of possible token dropping rates. For example, the system can sample the token dropping rate from a Beta distribution or other distribution over a range of possible token dropping rates.

As another example, the system can determine the respective token dropping rate for the batch according to an index of the training step among training steps performed during the training. That is, the system can maintain a function that maps the index of the training step to a token dropping rate.

In some other cases, different images in a batch can have different token dropping rates.

For example, the system can determine the respective token dropping rate for a given training image in the batch according to an index of the training image among training images processed during the training. That is, the system can maintain a function that maps the index of the training image to a token dropping rate.

As another example, the system can determine the token dropping rate based on the resolution of the training image. As one example, the system can sample the token dropping rate for a given image from a distribution that depends on the resolution of the training image, e.g., that has a mean that is based on the resolution of the training image.

For each of the two or more training images, the system determines, in accordance with the token dropping rate for the training image, whether to select any of the tokens representing patches from the two or more training images for removal (step 306).

The system generates an input sequence that includes only the tokens for the two or more images that were not selected for removal (step 308).

FIG. 4 is a flow diagram of an example process 400 for obtaining a batch of training examples when the system employs resolution sampling. For convenience, the process 400 will be described as being performed by a system of one or more computers located in one or more locations. For example, a neural network system, e.g., the neural network system 100 of FIG. 1, appropriately programmed, can perform the process 400.

The system samples an original batch of original training examples (step 402). As described above, each original training example includes an original training image, with each original training image having a respective original resolution and a respective original aspect ratio. For example, the system can sample the original batch from a larger set of training examples that is available to the system for use in training the neural network.

The system modifies the original images in the original training examples (step 404).

More specifically, for each original training image, the system samples a resolution for the original training image and then modifies the original training image to have the sampled resolution while maintaining the original aspect ratio of the original training image. That is, the total number of pixels in the original image is resampled to match the sampled resolution while the aspect ratio is preserved.

As one example, the system can sample the resolution from a fixed set of resolutions, e.g., by sampling the resolution from a uniform distribution over the resolutions in the fixed set.

The system generates a batch of training examples that includes the modified images (step 406). That is, the training example corresponding to any given original training example includes the modified training image generated from the original training image in the training example and any other information that was in the original training example, e.g., a training text if the neural network is being trained through contrastive learning or a ground truth label if the neural network is being trained to perform classification.

FIG. 5 shows an example 500 of generating and processing an input sequence during a given training step during the training step.

In particular, in the example 500, the image processing neural network is a neural network that includes one or more self-attention layers that each apply self-attention.

As shown in the example 500, the system selects three input images 502 (image 1, image 2, and image 3).

The system then “patchifies” 504 each of the input images 502 to divide each of the images 502 into patches.

After dividing the images into patches, the system can perform token dropping 506 on each input image 502 to determine whether any of the tokens representing the patches of any of the images should be removed.

The system then generates an input sequence 510 (“packed sequence”) that includes only the tokens that were not removed from the three input images. In particular, the input sequence 510 includes a respective subsequence for each of the three input images. More specifically, the input sequence 510 includes a concatenation of a plurality of subsequences that each include tokens representing patches from a respective one of the three training images.

In the example 500, because the concatenation of the plurality of subsequences includes fewer than the maximum number of tokens, the system has appended two masking tokens in the “pad” portion of the input sequence 510 so that the input sequence 510 has the maximum number of tokens.

The system then processes the input sequence 510 using a sequence of self-attention blocks 520. The self-attention network blocks 520 each apply self-attention over the tokens in the input sequence 510 to update at least a subset of the tokens in the input sequence. For example, the masking tokens in the “pad” section of the input sequence 510 can be masked out so they are not updated by the self-attention layer.

To ensure that tokens for a given image do not influence the final output for other images, for each of the self-attention network blocks 520, the self-attention is masked so that the tokens for each corresponding image are only updated using the tokens for the corresponding image and not the tokens for any other corresponding images or padding.

In the example 500, once the neural network has processed the sequence through the blocks 520, the neural network applies a pooling operation 530, e.g., global average pooling or another type of pooling, to the tokens to generate a respective pooling representation for each of the three images corresponding to the input sequence. Once the pooling representations have been generated, the neural network can generate the respective training output for each image using the pooling representation for the image.

As one example, for contrastive learning tasks, the system can use the pooling representation as the embedding of the input image or can apply one or more transformations, e.g., learned projections or other learned operations, to the pooling representation to generate the embedding.

As another example, for classification tasks, the system can process the pooling representation using an output subnetwork to generate the classification output. For example, the output subnetwork can include one or more fully-connected layers followed by a softmax layer.

To ensure that tokens for a given image do not influence the final output for other images, the pooling operation 530 is masked so that the pooling representation for each corresponding image is only generated using the tokens for the corresponding image and not the tokens for any other corresponding images., i.e., only the tokens for the corresponding image and not the tokens for any other corresponding images or padding are pooled to generate the pooling representation.

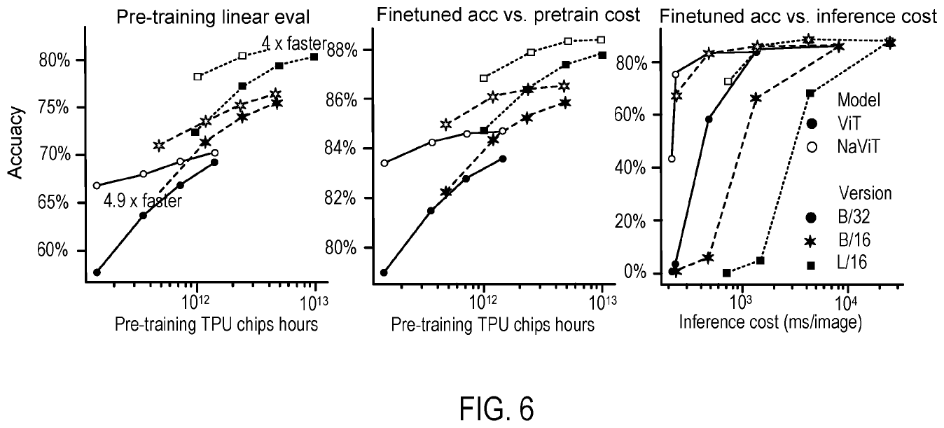

FIG. 6 shows an example 600 of the performance of the described techniques. In particular, the example 600 shows the performance of various architectures trained using the described techniques relative to the same architectures trained using a ViT training technique.

As can be seen from FIG. 6, the described techniques outperform the ViT models along a variety of dimension: model accuracy given pre-training hours, fine-tuned accuracy at a given pre-training cost, and on fine-tuned accuracy at a given inference cost.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training an image processing neural network having image processing neural network parameters to perform a first task, the method comprising, at each of a plurality of training steps:
obtaining a batch of training examples, each training example comprising a respective training image;
for each training image:
dividing the training image into a respective plurality of patches; and
generating a respective token representing each of the patches;
generating one or more input sequences, wherein each input sequence corresponds to two or more of the training images in the batch and is a sequence of tokens that comprises tokens representing patches from two or more corresponding training images;
processing each input sequence using the image processing neural network to generate a respective training output for each corresponding training image; and
training the image processing neural network on a first loss function for the first task using the training outputs for the training images in the batch.

2. The method of claim 1, wherein:
the training output generated by the image processing neural network for each image is an image embedding of the image in an embedding space;
the image processing neural network is trained jointly with a text encoder neural network having text encoder neural network parameters and configured to process a text segment to generate a text embedding of the text segment in the embedding space,
each training example further comprises a respective training text segment, and the method further comprises:
for each training text segment:
processing the training text segment using the text encoder neural network to generate a training text embedding of the training text segment; and
wherein the first loss function is a contrastive loss function that is based on similarities between the training text embeddings and the training image embeddings.

3. The method of claim 1, wherein the training output generated by the image processing neural network for each image is an image classification output for the image and wherein the loss function is a classification loss relative to a ground truth classification for the image.

4. The method of claim 1, further comprising:
after training the image processing neural network on the first loss function for the first task:
adapting the image processing neural network to perform a downstream computer vision task.

5. The method of claim 4, wherein the downstream computer vision task is one of:
image classification,
object detection,
image segmentation,
depth prediction,
video understanding, or
a multi-modal text and vision task.

6. The method of claim 5, wherein multi-modal text and vision task is image captioning or a visual question answering task.

7. The method of claim 5, wherein the computer vision task is open vocabulary object detection.

8. The method of claim 1, wherein generating one or more input sequences, wherein each input sequence corresponds to two or more of the training images in the batch and is a sequence of tokens that comprises tokens representing patches from two or more corresponding training images comprises:
selecting two or more of the training images;
determining, for each of the two or more training images, a respective token dropping rate; and
for each of the two or more training images, determining, in accordance with the token dropping rate for the training image, whether to select any of the tokens representing patches from the two or more training images for removal; and
generating an input sequence that comprises only the tokens for the two or more images that were not selected for removal.

9. The method of claim 8, wherein the respective token dropping rate is the same for all of the training images in the batch.

10. The method of claim 9, wherein determining, for each of the two or more training images, a respective token dropping rate comprises randomly sampling the respective token dropping rate for the batch from a set of possible token dropping rates.

11. The method of claim 9, wherein determining, for each of the two or more training images, a respective token dropping rate comprises determining the respective token dropping rate for the batch according to an index of the training step among training steps performed during the training.

12. The method of claim 1, wherein generating a respective token representing each of the patches comprises:
generating a patch embedding of the patch;
generating a positional embedding of a position of the patch within the corresponding training image; and
combining the patch embedding of the patch and the positional embedding of the patch to generate the respective token representing the patch.

13. The method of claim 12, wherein generating a patch embedding of the patch comprises:
processing the intensity values of the pixels in the patch using a patch embedding subnetwork to generate the respective patch embedding.

14. The method of claim 13, wherein training the image processing neural network comprises:
training the patch embedding subnetwork using gradients of the first loss function.

15. The method of claim 12, wherein generating a positional embedding of a position of the patch within the corresponding training image comprises:
generating a first embedding of an x coordinate of the position of the patch within the corresponding training image;
generating a second embedding of a y coordinate of the position of the patch within the corresponding training image; and
combining the first and second embeddings to generate the positional embedding of the position of the patch.

16. The method of claim 1, wherein each input sequence comprises a concatenation of a plurality of subsequences that each comprise tokens representing patches from a respective one of the two or more corresponding training images.

17. The method of claim 16, wherein generating each input sequence comprises:
determining whether the concatenation of the plurality of subsequences includes fewer than a maximum number of tokens; and
in response to determining that the concatenation of the plurality of subsequences includes fewer than a maximum number of tokens, appending one or more masking tokens to the input sequence so that the input sequence has the maximum number of tokens.

18. The method of claim 1, wherein the image processing neural network has a plurality of self-attention network blocks that each apply self-attention over the tokens in each input sequence to update at least a subset of the tokens in the input sequence, and wherein, for each of the self-attention network blocks, the self-attention is masked so that, for each input sequence, the tokens for each corresponding image are only updated using the tokens for the corresponding image and not the tokens for any other corresponding images.

19. The method claim 1, wherein, for at least one of the input sequences, the two or more corresponding images include at least two images with different resolutions.

20. The method of claim 1, wherein, for at least one of the input sequences, the two or more corresponding images include at least two images with different aspect ratios.

21. The method of claim 1, wherein obtaining a batch of training examples comprises:
sampling an original batch of original training examples, each original training example comprising an original training image having a respective original resolution and a respective original aspect ratio;
for each original training image:
sampling a resolution for the original training image; and
modifying the original training image to have the sampled resolution while maintaining the original aspect ratio of the original training image.

22. The method of claim 21, wherein two or more of original training images have different respective original aspect ratios.

23. A system comprising one or more computers and one or more storage devices storing instructions that when executed by the one or more computers cause the one more computers to perform operations for training an image processing neural network having image processing neural network parameters to perform a first task, the operations comprising, at each of a plurality of training steps:
obtaining a batch of training examples, each training example comprising a respective training image;
for each training image:
dividing the training image into a respective plurality of patches; and
generating a respective token representing each of the patches;
generating one or more input sequences, wherein each input sequence corresponds to two or more of the training images in the batch and is a sequence of tokens that comprises tokens representing patches from two or more corresponding training images;
processing each input sequence using the image processing neural network to generate a respective training output for each corresponding training image; and
training the image processing neural network on a first loss function for the first task using the training outputs for the training images in the batch.

24. One or more non-transitory computer storage media storing instructions that when executed by one or more computers cause the one more computers to perform operations for training an image processing neural network having image processing neural network parameters to perform a first task, the operations comprising, at each of a plurality of training steps:
obtaining a batch of training examples, each training example comprising a respective training image;
for each training image:
dividing the training image into a respective plurality of patches; and
generating a respective token representing each of the patches;
generating one or more input sequences, wherein each input sequence corresponds to two or more of the training images in the batch and is a sequence of tokens that comprises tokens representing patches from two or more corresponding training images;
processing each input sequence using the image processing neural network to generate a respective training output for each corresponding training image; and
training the image processing neural network on a first loss function for the first task using the training outputs for the training images in the batch.
